(19) United States
(12) Patent Application Publication
(10) Pub. No.: US 2002/0114688 A1
(43) Pub. Date: Aug. 22, 2002

(54) Dumping and transporting accessory having a telescoping lift with a pivot mounted trolley

(76) Inventors: David A. Poindexter, Stoughton, WI (US); Steven D. Spoon, Janesville, WI (US); Bryan J. Bolden, Orfordville, WI (US)

Correspondence Address: MICHAEL BEST & FRIEDRICH, LLP, 100 E WISCONSIN AVENUE, MILWAUKEE, WI, 53202, US

(21) Appl. No.: 10/001,620

(22) Filed: Oct. 23, 2001

Related U.S. Application Data
(60) Provisional application No. 60/242,933, filed on Oct. 24, 2000.

(51) Int. Cl. B60P 1/04

(52) U.S. Cl. 414/477

(57) ABSTRACT

A transporting accessory for a vehicle that includes a base frame that is mountable to the vehicle. The base frame includes two support members. The accessory also includes a second frame that has two extension members. Each extension member is slidably supported by one of the support members. A trolley or carriage is pivotally mounted to the second frame. The carriage has two parallel side arms. Each arm has a guide device. A transport device with one or more tracks is engaged to the carriage. The transport support is movable along a path of travel between a first, retracted position and a second, extended position. The invention also provides a method of loading and unloading cargo from a transporting accessory for a vehicle.

### FIELD OF THE INVENTION

The present invention relates to a dumping and transporting accessory for vehicles. More particularly, the present invention relates to an accessory that facilitates the loading and unloading of material and devices into and out of a vehicle.

### BACKGROUND OF THE INVENTION

It is known in the art to provide auxiliary transporting devices for pick-up trucks and other vehicles to allow for the unloading of material such as dirt, rocks, or the like from the bed of the trucks. It is also known to provide devices to facilitate the loading and unloading of equipment and other items from vehicles.

Even so, such devices are often difficult to attach and detach from the vehicle, only attach to one size of vehicle, are difficult and dangerous to operate, or have an uncontrolled dumping action that can damage the articles or items being transported, the vehicle, the auxiliary device, or one or more the above.

### SUMMARY OF THE INVENTION

Accordingly, there is a need for an improved dumping and transporting accessory for a vehicle. The invention provides such an accessory. In one embodiment, the accessory includes a base frame that is mountable to the vehicle. The base frame includes two support members. The accessory also includes a second frame that has two extension members. Each extension member includes at least one roller that is slidably supported by one of the support members. Each extension member can move along a path of travel between a first, retracted position and a second, extended position. The accessory further includes a trolley or carriage that is pivotally mounted to the second frame. The carriage has two parallel side arms, which have at least one roller each. The accessory also includes a transport support that has two tracks. Each track slidably engages at least one roller of one of the two parallel side arms of the carriage. The transport support is movable along a path of travel between a first, retracted position and a second, extended position.

In another embodiment, the invention provides a dumping and transporting accessory much like the one just described. However, in addition to the components described previously, the second embodiment also includes a drive assembly that is operable to move the extension members between the first, retracted position and the second, extended position. The drive assembly may take the form of one or more drive chains coupled to the extension members. The drive assembly may also take the form of a winch with a cable routed through and coupled to various components of the accessory. The accessory also includes an actuating mechanism that is interconnected to the second frame and the carriage. The actuating mechanism is operable to move the transport support between the first, retracted position and the second, extended position.

According to yet a further aspect, the invention provides a method of loading and unloading cargo into and out of a vehicle. The method includes mounting a base frame of a transporting accessory to the vehicle. The method also includes loading the items into a transport support of the transporting accessory. A drive assembly is activated to move two extension members of a second frame of the transporting accessory along a path of travel between a first, retracted position to a second, extended position. The method also includes activating an actuating mechanism to move the transport support along a path of travel between a first, retracted position to a second, extended position. The actuating mechanism is coupled to the second frame and a carriage. The carriage is pivotally mounted to the second frame and has two parallel side arms. The actuating mechanism is activated to pivot the carriage, which causes the transport support to move along a path of travel between the second, extended position to the first, retracted position. The drive assembly is activated a second time to again move the two extension members along a path of travel between the second, extended position and the first, retracted position.

Other features of the invention are set forth in the attached drawings, detailed description, and claims.

### BRIEF DESCRIPTION OF THE DRAWINGS

FIG. 1 is a perspective view of one embodiment of a dumping and transporting accessory device of the invention.

FIG. 2 is a second perspective view of the device of FIG. 1 in a dumping position.

FIG. 3 is a perspective view of a second embodiment of the invention.

FIG. 4 is a perspective view of a third embodiment of the invention.

FIG. 5 is a perspective view of the device of FIG. 4 with a transport support removed.

FIG. 6 is an enlarged, partial perspective view of a portion of the device of FIG. 4.

FIG. 7 is an enlarged, partial perspective view of a braking mechanism of the device of FIG. 4.

FIG. 8 is a perspective view of a forth embodiment of the invention.

FIG. 9 is an enlarged perspective view of a portion of the transporting device of FIG. 8.

### DETAILED DESCRIPTION OF THE INVENTION

Before embodiments of the invention are explained, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

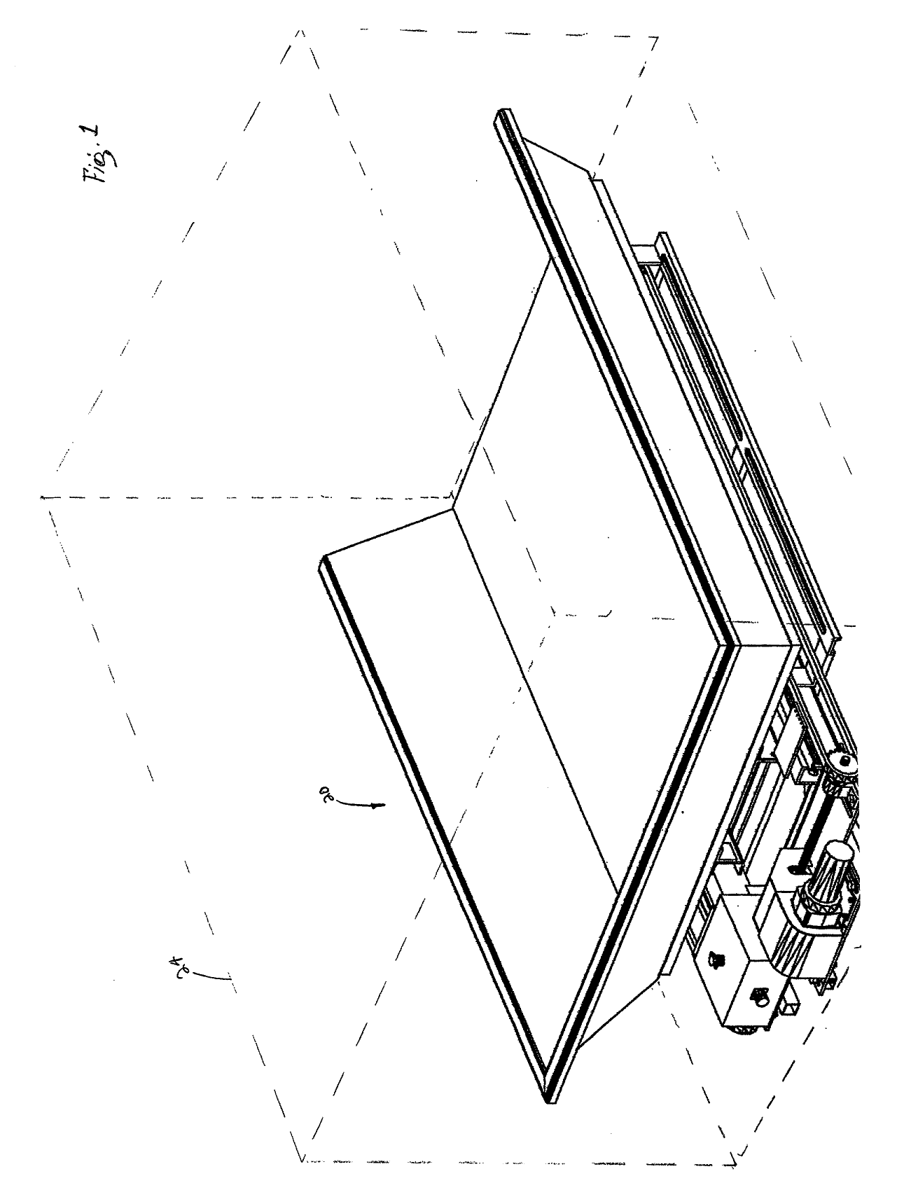

FIG. 1 illustrates a dumping and transporting accessory or device 20. Devices similar to the device 20 are often generically referred to as lifts. In FIG. 1, the device 20 is shown in a first or retracted position. The device 20 is mountable to a vehicle 24. In the embodiment shown, the device 20 is configured to fit in a pick-up truck or similar vehicle. However, the device 20 could be mounted on and find usefulness with a variety of overland and other vehicles.

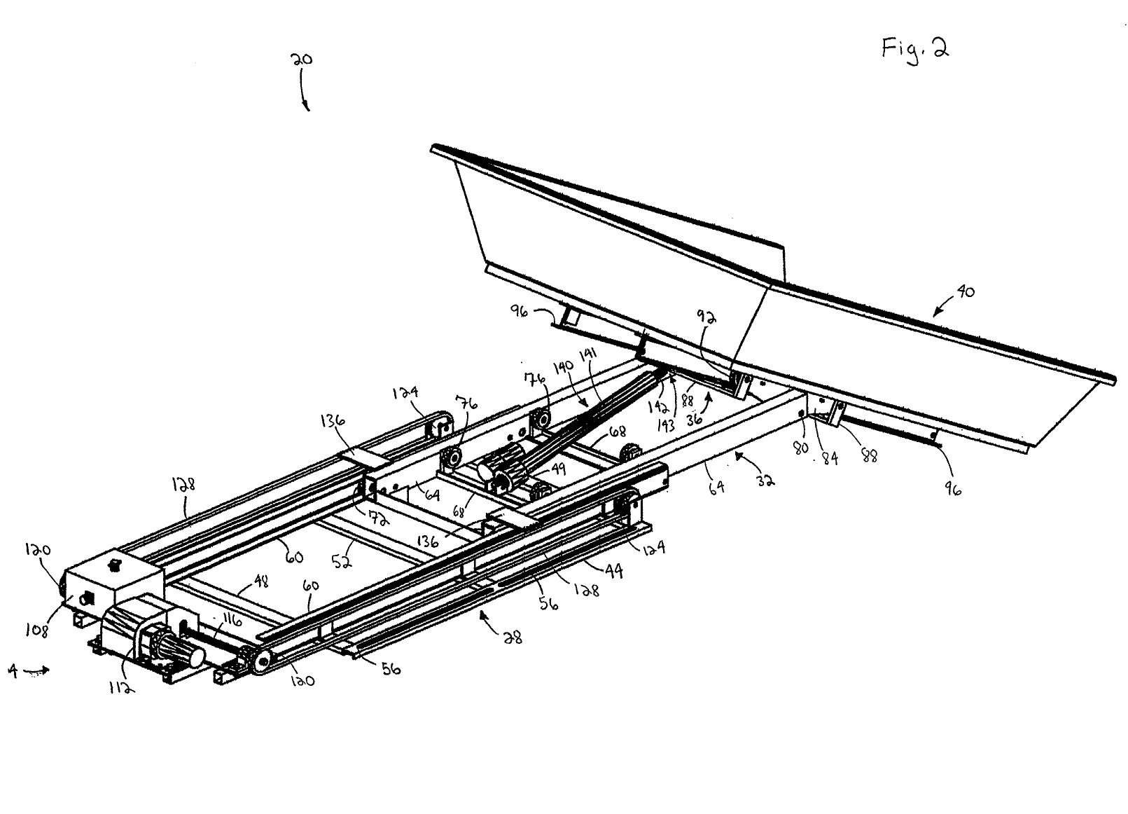

As best seen by reference to FIG. 2, the device 20 includes a base frame 28, a second frame 32, a trolley or carriage 36, and a dump bed 40 (generically, a type of transport support). In FIG. 2, the device 20 is shown in a second extended position.

The base frame 28 is mountable to the vehicle 24 and includes longitudinal side beams 44 (one shown), end beams 48 and 49, and a lateral cross beam 52. The end beams 48 and 49 and cross beam 52 interconnect the side beams 44 and provide stability to the side beams 44. The side beams 44 have apertures 56 that fasteners (not shown) insert into to mount the device 20 to the vehicle 24. The base frame 28 also includes longitudinal support members 60 that are mounted to the end beams 48 and cross beams 52.

The second frame 32 telescopes with respect to and is extend ably mounted to the base frame 28. The second frame 32 includes longitudinal extension members 64 and lateral support members 68 that interconnect the extension members 64. The second frame 32 also includes a plurality of guide rollers 72 (one shown) that engage the support members 60 of the base frame 28. The rollers 72 roll within the support members 60 and allow the extension members 64 to extend along the support members 60 until the rollers 72 contact a protrusion or stop (not shown) within each support member 60 to prevent further extending of the extension members 64. The second frame 32 also includes transport support rollers 76 mounted on the extention members 64 that the dump bed 40 rolls upon. One or more of the guide devices discussed below could be substituted for the transport support rollers 76.

Before discussing additional details of the device 20, it should be noted that the rollers and tracks discussed are just one way of achieving a sliding, telescoping interaction between components of the device. Interacting protrusions and grooves, bearings and guides, whether made from metals, composites, plastics or other materials, or coated or otherwise exploiting low-friction materials, and a variety of other devices could be used to provide telescoping interaction of components in the device 20 and are within the scope of the invention. The choice of such components is based in part on considerations of cost, the weight of the load to be handled, and the environment in which the device is operated.

The carriage 36 is pivotally mounted to the second frame 32 at pivots 80 (one shown) and include parallel longitudinal side arms 84, lateral support beams 88, and a plurality of dumping rollers 92 (one shown). Devises other than rollers could be mounted to the carriage 36, including guide devices such as protrusions, bearings, slides, and tracks. The support beams 88 interconnect and provide stability to the side arms 84. The dumping rollers 92 are rotatably mounted to the side arms 84. An important feature of the carriage 36 is its location at a single pivot point or axis (defined by the two pivots 80) located at a distal end of the extension members 64. This positioning allows the device to extend out of a bed or cargo area of a vehicle a sufficient distance to allow the transport support to telescope with respect to the carriage 36 and provide clearance from the vehicle s bed or cargo area to allow pivoting or dumping of the dump bed 40.

In the embodiment shown, the transport support is illustrated as a dump bed 40. However, the transport support could be a staked bed, a flat bed, a support bed having depressions for tires, snowmobile skis, or any other depressions depending on the item being transported, or another bed, bin, or cargo support designed to hold an item or load of interest. A transport support having apertures therein for tie downs, or any other suitable transport support could be used and is within the scope of the invention. The dump bed 40 is extend ably mounted to the carriage 36 and includes a plurality of longitudinal dumping tracks 96. The dumping rollers 92 of the carriage 36 are engageable with and roll within the dumping tracks 96 to allow the dump bed 40 to extend until the dumping rollers 92 contact a stop (not shown) within the tracks 96 that prevents further extension of the dump bed 40. The dump bed 40 supports objects (not shown) that are to be transported by the vehicle 24.

The device 20 also includes a drive assembly 104 that extends and retracts the second frame 32 along the base frame 28. The drive assembly 104 includes a housing 108, a reversible motor 112, a drive shaft 116, drive gears 120, free turning gears 124, and drive chains 128. The drive assembly 104 can be mounted to the base frame 28 or to the interior of the vehicle 24. The drive assembly 104 can be powered by the vehicles electric system or by a power source fitted on the vehicle along with the device 20 such as a battery (not shown). The motor 112 is supported within the housing 108 and can rotate the drive shaft 116 clockwise and counter clockwise depending on whether extension or retraction of the extension members 64 is desired. The drive gears 120 are mounted to each end of the drive shaft 116 and include a plurality of gear teeth (not shown). The gear teeth are interconnectable with the drive chains 128 that are wrapped around the drive gears 120. The free turning gears 124 are pivotally mounted to each side of the base frame 28 and each drive chain 128 wraps around a free turning gear 124. The second frame 32 includes brackets 136 that are mounted to each drive chain 128 and cause the extension members 64 to extend along the support members 60 depending on the direction of the drive chains 128.

The device 20 also includes an actuating mechanism 140 for rotating the carriage about pivots 80. This rotation causes the tracks 96 to slide or move with respect to the carriage 36 between a retracted position and an extended position. The actuating mechanism 140 may be any one of a number of different mechanisms such as electric or hydraulic linear actuators, rack and pinion systems, screws, or other devices, but is illustrated as an electric actuator 141 of conventional design. The electric actuator is connected in fluid flowing relation relative to a source of hydraulic fluid, under pressure (not shown). The electric actuator 141 includes a movable ram 142. The ram 142 has a distal end 143, which is connected by means of a pin (not shown), in pivotal force engaging relation relative to the support beams 88. The cylinder 141 is connected to the support member 68 by means of a pin (not shown). Since the support member 68 is mounted to the extension members 64 and is movable therewith, extension or retraction of the ram 142 causes the carriage 36 to rotate about pivots 80.

Extension of the ram 142 also causes the dump bed 40 to move with respect to the carriage 36. By extending the ram 142, the carriage 36 rotates and becomes inclined with respect to the second frame 32, therefore, causing the tracks 96 of the dump bed 40 to slide with respect to the carriage 36 by the force of gravity.

Having focused on the structural components of the device 20, its operation will now be described in greater detail.

The device 20 is in the retracted position, when the extension members 64 are retracted with respect to the support members 60. To extend the extension members 64 and move the device 20 to the extended position, the drive assembly 104 is activated. The motor 112 rotates the drive shaft 116 causing the drive gears 120 and drive chains 128 to move in a direction to extend the extension members 64 along the support members 60. After the extension members 64 are fully extended from the support members 60, the actuating mechanism 140 is actuated to extend the ram 142. The extension of the ram 142 causes the carriage 36 to rotate about the pivots 80, such that, the dump bed 40 is inclined with respect to the base and second frames 28 and 32. As the carriage 36 rotates about the pivots 80, the dumping tracks 96 slide on the dumping rollers 92. The rotating and sliding action of the dump bed 40 causes the objects supported by the dump bed 40 to be dumped therefrom. When the dump bed 40 is fully rotated and extended relative to the second frame 32, the dump bed 40 and dumping tracks 96 are in the extended position, and the device 20 is in the extended position. To return the device 20 to the retracted position, the actuating mechanism 140 is actuated and retracts the ram 142. The retracting of the ram 142 rotates the dump bed 40 about the pivots 80 so that the dump bed is generally parallel to the base and second frames 28 and 32. The dump bed 40 and dumping tracks also retract along the carriage 36 to move the dump bed 40 and dumping tracks 96 to the retracted position. The drive assembly 104 is reversed from the original direction and causes the extension members 64 to retract within the support members 60 until the extension members 64 are nested with respect to the support members 60.

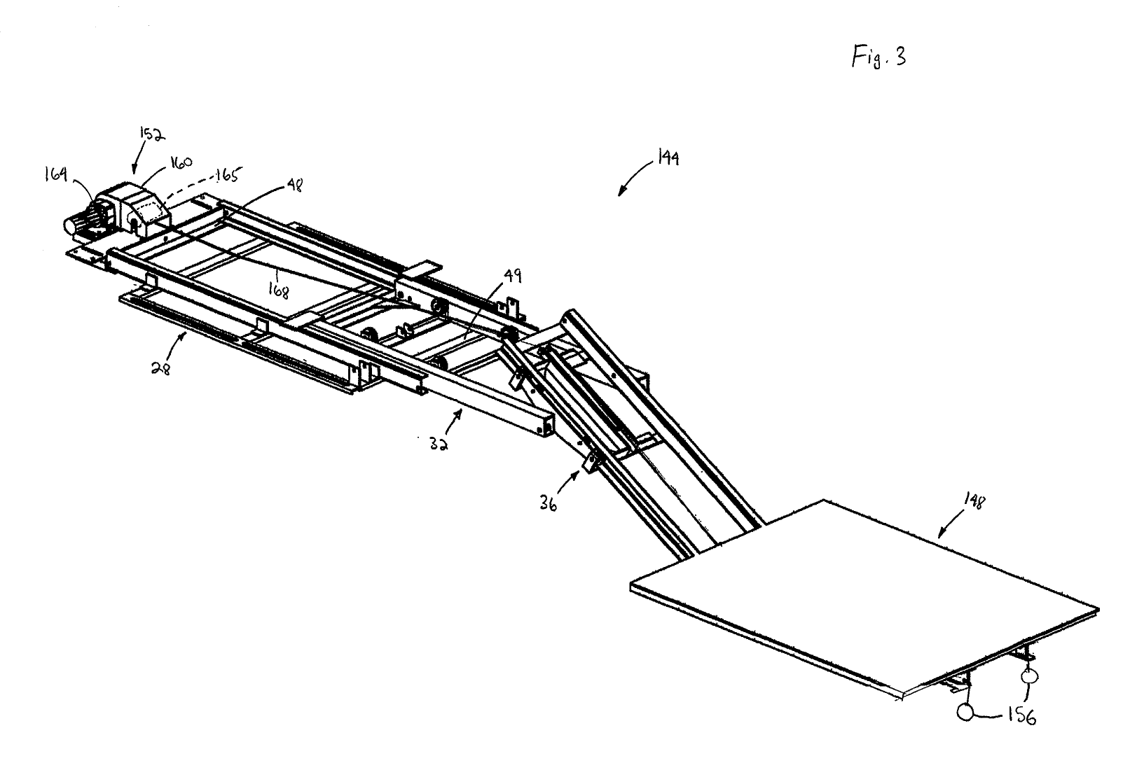

Referring to FIG. 3, another embodiment of the invention, a transporting device 144, is illustrated. Many of the components in the alternate embodiment are similar to the components in the previous embodiment. Therefore, like components will be given like reference numbers.

The transporting device 144 includes a transport platform 148 instead of the dump bed 40, and a drive assembly 152 that controls the movement of the device 144 between a retracted position, wherein the extension members 64 and transport platform 148 are nested along the support members 60 and carriage 36, respectively, and an extended position, wherein the extension members 64 and transport platform 148 are extended along the support members 60 and the carriage 36, respectively. The device 144 is arranged at an angle within the vehicle 24 so that the end beam 48 of the base frame 28 is elevated with respect to the end beam 49. The angled arrangement may be achieved by mounting a shim or block under the end beam 48 such that there is angle of incline about 3 to 5° from the front to the rear of the device 144. Arrangement of the device 144 in such a manner, biases the device 144 and loads thereon (via gravity) toward the extended position.

The transport platform 148 is extend ably mounted to the carriage 36 and includes rollers 156 that contact the ground. The rollers 156 allow the transport platform 148 to roll on the ground while moving with respect to the carriage 36. Although rollers are preferred, skids or other devices could also be used to facilitate motion of the transport platform 148 over an underlying surface. The transport platform 148, when fully extended, is generally parallel with the ground to facilitate the loading and unloading of objects onto the transport platform 148. This is an advantage over other lifts and loading devices, which are often designed such that the load or item to be transported must be inclined by the person operating the lift or manually moved into the bed or cargo area after the lift has moved the cargo to a vertical position roughly parallel to the height of the cargo area.

The drive assembly 152 can be mounted to the base frame 28 or the vehicle 24, and can be powered by the vehicle s electric system or by another power source such as a battery (not shown). The drive assembly 152 includes a housing 160 and a winch 164 with a drum 165 having a cable 168 wound thereon. The cable 168 has one end attached to the winch 164 and a second end attached to the transport platform 148. In the retracted position, the cable 168 is substantially wound onto the winch 164. To move the device 144 from the retracted position to the extended position, the winch 164 is switched from a locked position, in which the cable 168 can not be unwound from the drum 165, to an unlocked position, in which the cable 168 can be unwound from the drum 165. Due to the angled arrangement of the device 144, the extension members 64 and the transport platform 148 begin to extend along the support members 60 and carriage 36, respectively, when the winch 164 is switched to the unlocked position. The drive assembly 152 controls the rate at which the extension members 64 and transport platform 148 extend. As the extension members 64 approaches full extension and the transport platform 148 extends along the carriage 36, the carriage 36 begins to rotate about the pivots 80. The rollers 156 on the transport platform 148 contact the ground as the carriage 36 rotates, and allow the transport platform 148 to continue extending along the carriage 36. The transport platform 148 extends either until the platform 148 reaches full extension along the carriage 36 or until the platform 148 is generally parallel with the ground.

The device 144 is moved from the extended position to the retracted position by switching the winch 164 to a wind position, wherein the cable 168 is wound onto the drum 165. The winch 164 fully retracts the transport platform 148 along the carriage 36 and rotates the carriage 36 toward being generally parallel with the base and second frames 28 and 32. The extension members 64 are then retracted along the support members 60 by the winch 164, until the device 144 is in the retracted position.

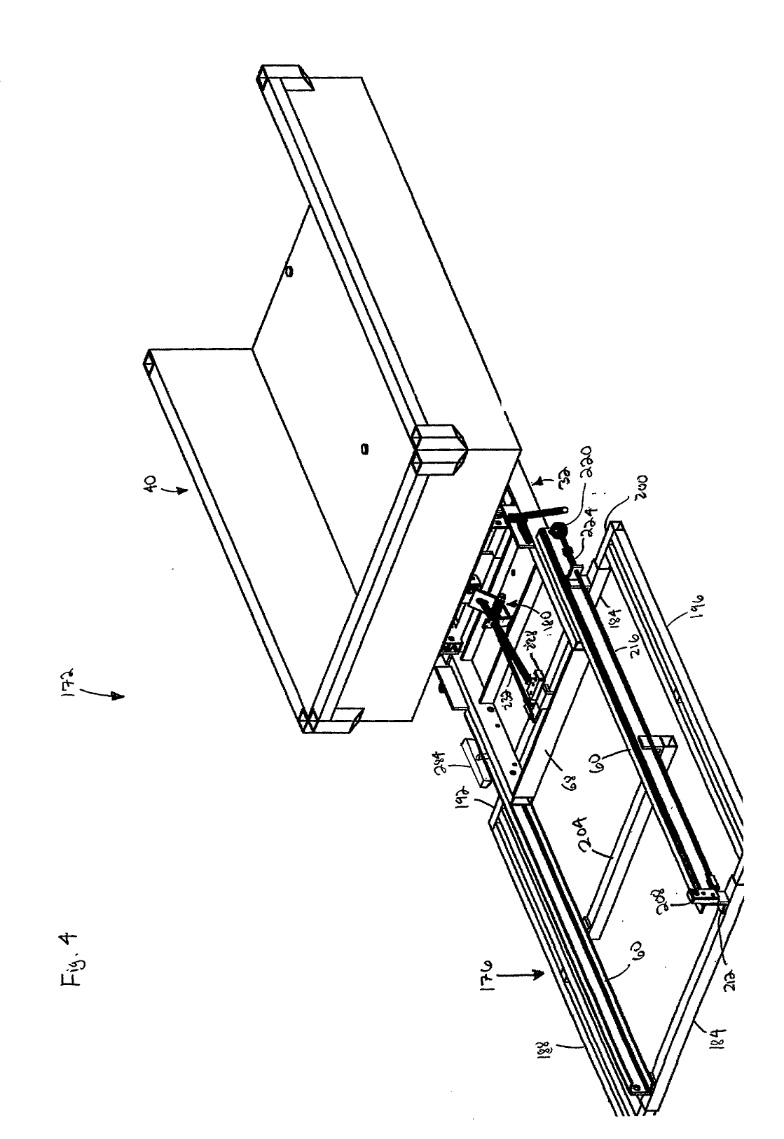

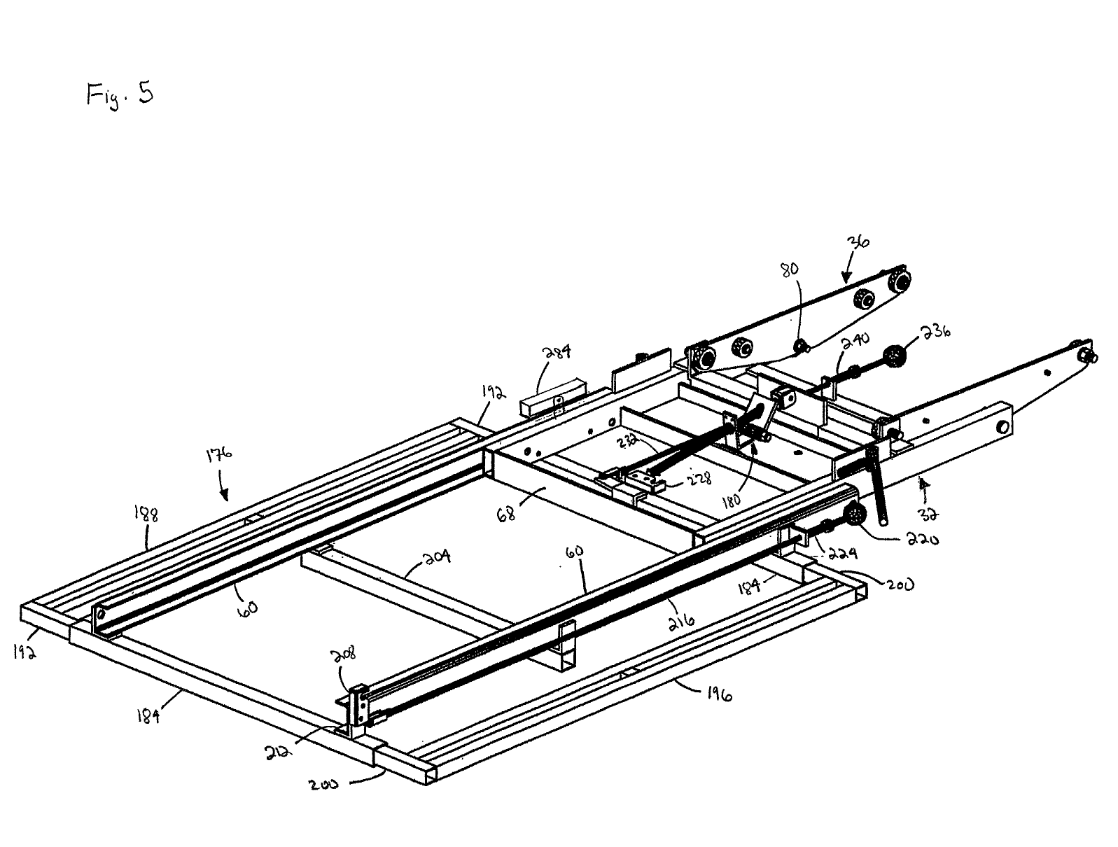

Referring to FIGS. 4 and 5, another embodiment of the invention, a transporting device 172, is illustrated. Again, like components are given like reference numbers. The device 172 is manipulated manually, but could be manipulated by a drive assembly (as described above), a motor, or any other power source. The device 172 is, in one embodiment, designed to be mounted within the cargo area of an SUV, stationwagon, or similar vehicle.

The device 172 includes an adjustable base frame 176 that can adjust in width to accommodate vehicles of varying widths, and an actuating mechanism 180 that controls a rate at which the dump bed 40 rotates about the pivots 80. The base frame 176 includes a pair of spaced apart rectangular tube members 184, a first support member 188 having a pair of projecting arms 192 slidably received by a respective end of the tube members 184, and a second support member 196 having a pair of projecting arms 200 slidably received by the respective other ends of tube members 184. The support members 188 and 196 are telescopically adjustable with respect to the tube members 184 to increase or decrease the width of the base frame 176. The support members 188 and 196 can be secured to the tube members 184 by any suitable fastening means known to those skilled in the art.

The longitudinal support members 60 are mounted to the tube members 184. A cross brace 204 extends between the support members 60 for additional strength and stability. A lock latch release device or latch mechanism 208 for releasably holding the second frame 32 is secured to a rear end 212 of the support member 60. A rod 216 mounted to and extending along the support member 60 is operatively connected to the latch mechanism 208. A handle or knob 220 and spring device 224 are attached to rod 216 to release the latch mechanism 208 to allow the second frame 32 to move along the base frame 176.

A latch mechanism 228 for releasably holding the dump bed 40 to the carriage 36 is mounted to one of the lateral support members 68 of the second frame 32. A rod 232 having a handle 236 and spring device 240 is operatively connectable to the latch mechanism 228 to allow the dump bed 40 to move along the carriage 36. The carriage 36 is pivotally mounted to the second frame 32 at the pivots 80, so that when the dump bed 40 is allowed to dump, the carriage 36 pivots about the pivots 80.

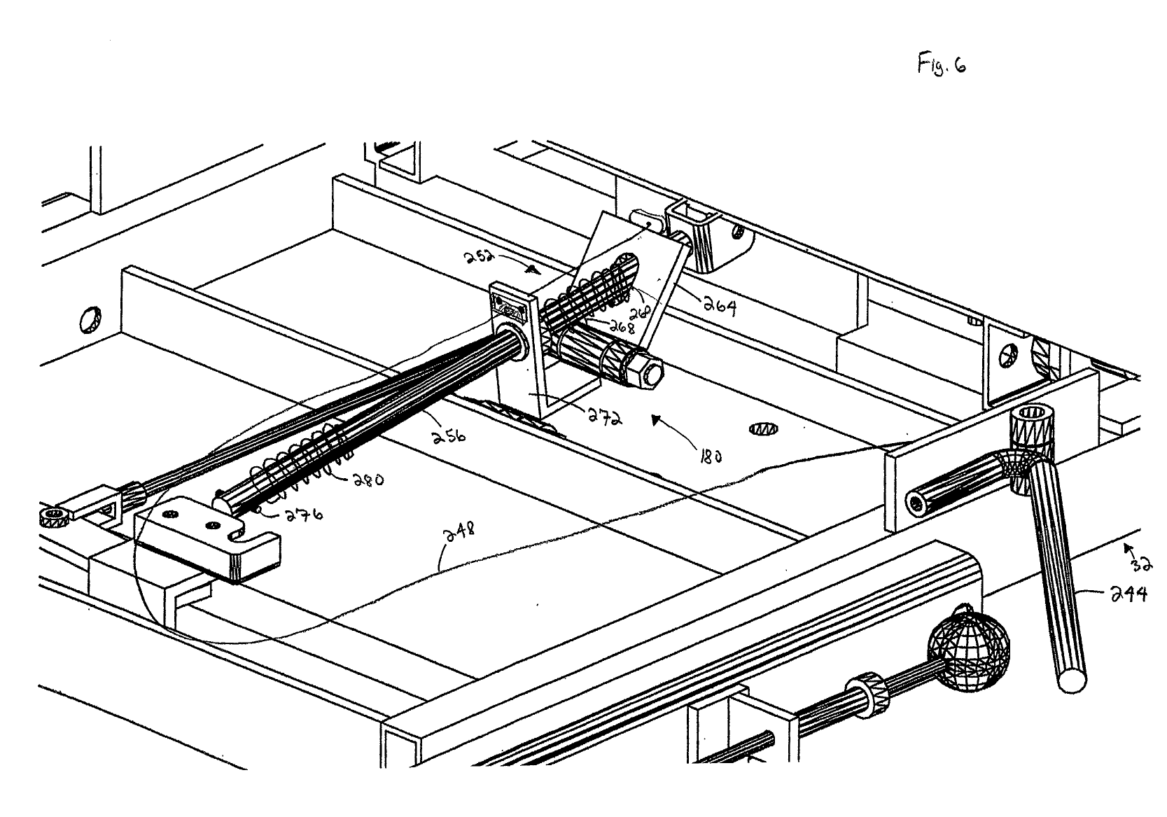

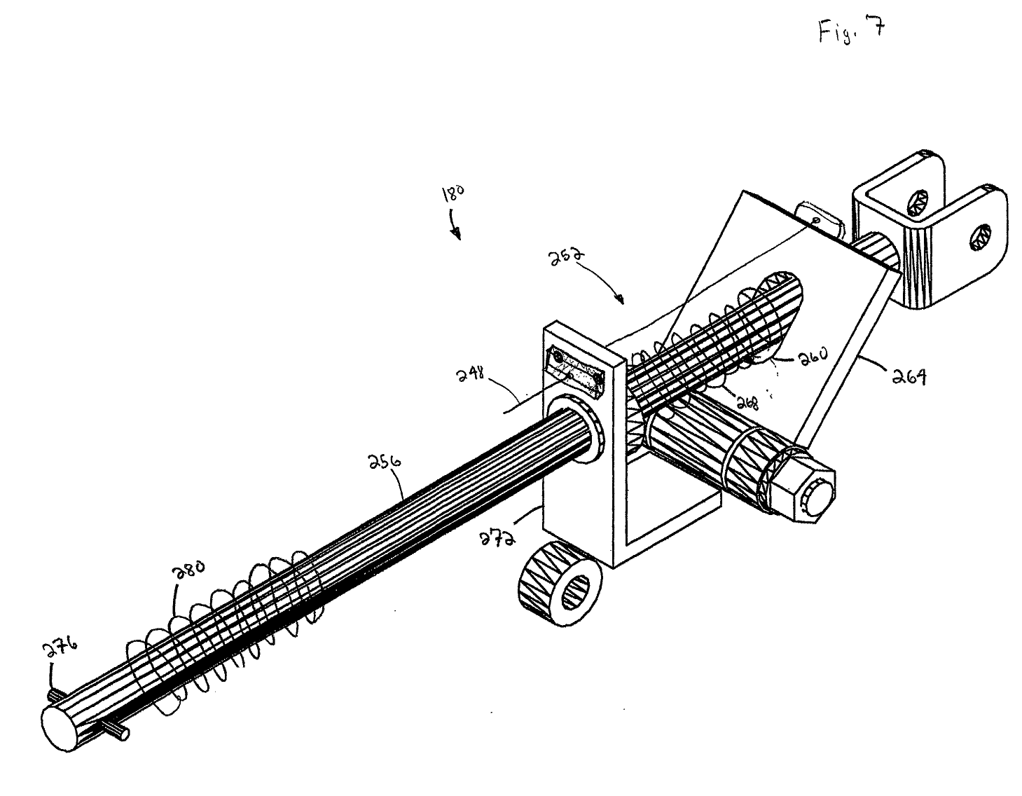

The actuating mechanism 180 is illustrated in more detail in FIGS. 6 and 7. As shown, the actuating mechanism 180 includes a handle or lever 244 mounted to the second frame 32, a cable 248 attached at one end to the lever 244 and at the other end to a hinge assembly 252, and a shaft 256 which extends through the hinge assembly 252.

Referring now to FIGS. 4-7, after the device 172 has been mounted to the vehicle 24, the second frame 32 is held by the latch mechanism 208 and the dump bed 40 is held by the latch mechanism 228. To utilize the device 172, the spring rod 216 is pushed in to release the lock latch mechanism 208. The extension members 64 and dump bed 40 are then free to extend along the support members 60 of the base frame 176 and the carriage 36, respectively. Manually pulling the dump bed 40 causes the guide rollers 72 of the second frame 32 to ride along support members 60 of the base frame 176. Stops (not shown) or the like are mounted to the base frame 176 to stop the forward movement of the extension members 64 when the extension members 64 have been fully extended.

To fully extend the dump bed 40, the spring rod 232 is pushed in to release the lock latch mechanism 228. Stops or similar devices are mounted to the dump bed 40 or the support members 68 of the second frame 32 to stop the forward movement of the dump bed 40 when the dump bed 40 has been fully extended. In this position, the actuating mechanism 180 holds the dump bed 40 generally parallel with the base and second frames 176 and 32. The shaft 256 of the actuating mechanism 180 is frictionally held within an aperture 260 of a hinge plate 264 of the hinge assembly 252 by a biasing spring 268. The spring 268 pushes hinge plate 264 away from a second hinge plate 272 of the hinge assembly 252. Force applied to the lever 244 causes the cable 248 to pinch or pull the hinge plates 264 and 272 together, thereby releasing the frictional engagement between the shaft 256 and the hinge plate 264. Thereafter, because the center of gravity of the dump bed 40 is beyond the pivots 80, the dump bed 40 tilts to dump the load held within the dump bed 40. As the dump bed 40 tilts, the shaft 256 is pulled through the hinge assembly 252. A stop pin 276 secured to one end of the shaft 256 prevents the shaft 256 from being pulled completely through the hinge assembly 252. A spring 280, which is positioned around shaft 256 and behind plate 272, controls the dumping motion of the dump bed 40 to prevent sudden, rapid dumping. As should be apparent, extremely rapid dumping could damage the device 172 or the vehicle 24.

As the dump bed 40 dumps, a reverse brake 284 pivotally mounted to the second frame 32 is pivoted into engagement with the base frame 176 to prevent rearward movement of the second frame 32. Rearward movement of the second frame 32 could cause injury to an individual operating the device 172.

Once the dumping action is completed, the dump bed 40 may be manually pivoted upwards until it is again generally parallel with the base and second frames 176 and 32. The movement of the dump bed 40 pushes the shaft 256 back through the hinge assembly 252. The biasing spring 268 causes the hinge plate 264 to again frictionally hold the shaft 256. Once the hinge plate 264 engages the shaft 256, the dump bed 40 is held in position. The movement of the dump bed 40 to the non-dumping position also pivots the reverse brake 284 out of engagement with the base frame 176 freeing the second frame 32 to move backwards with respect to the base frame 176. Once the dump bed 40 is generally parallel to the base and second frames 176 and 32, the dump bed 40 may be pushed backwards until the lock latch mechanism 228 is engaged to hold the dump bed 40. Lastly, the second frame 32 may be pushed backwards until the lock latch mechanism 208 is engaged to hold the second frame 32. Once the second frame 32 engages the lock latch mechanism 208, the device 172 is properly positioned for transportation or loading purposes.

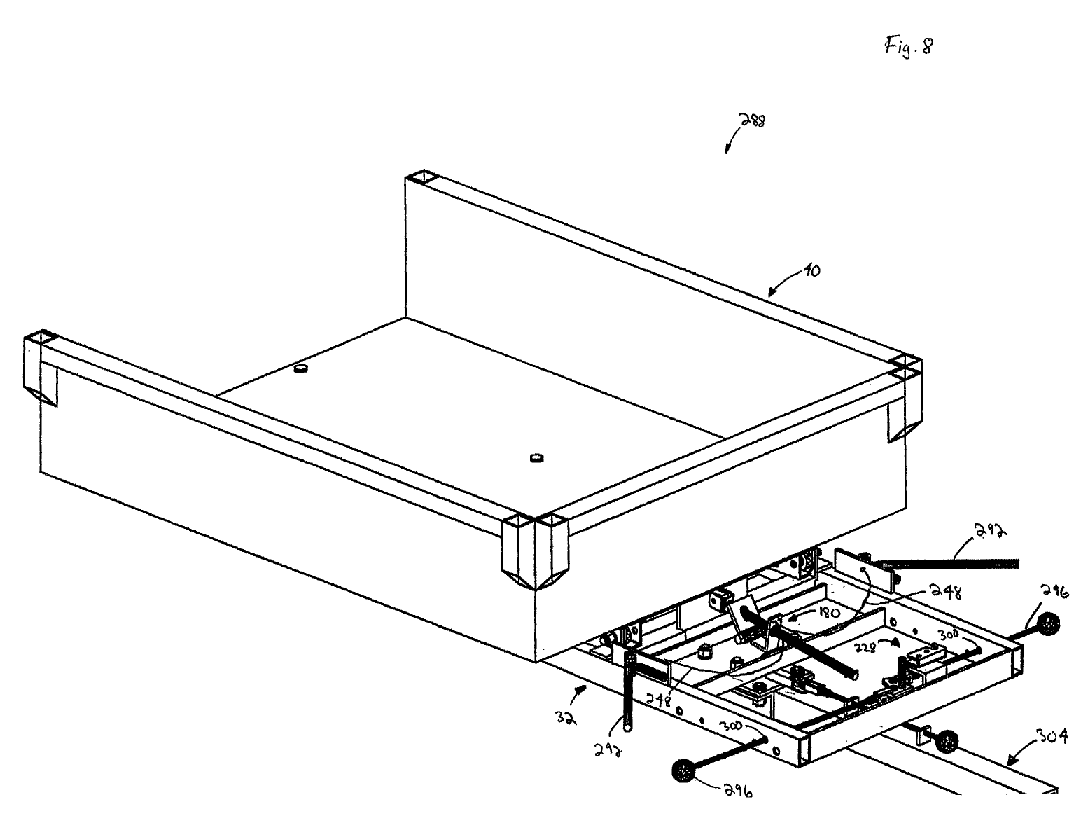

Yet another embodiment of the invention, a transporting device 288, is illustrated in FIG. 8. The device 288 is adapted to be mounted to a trailer hitch (not shown) of the vehicle 24. The second frame 32, dump bed 40, and the actuating mechanism 180 of the device 288 are similar to the components of the devices in previous embodiments. However, two lever handles 292 are provided so that the dump bed 40 can be dumped from either side of the device 288. Two spring rods 296 extending through holes 300 are provided to operate latch mechanism 228 from either side of the dump bed 40. A hitch member 304 is coupled to the second frame 32.

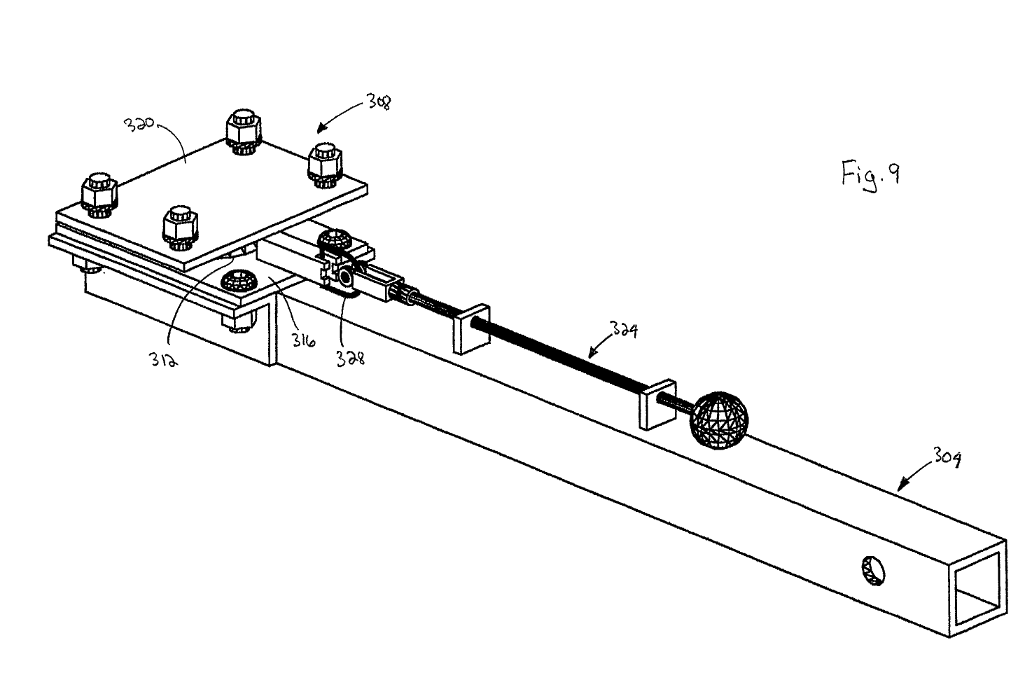

As best seen by reference to FIG. 9, the second frame 32 is swivelly mounted to the hitch member 304 by a turntable or swivel assembly 308. The swivel assembly 308 includes a swiveling mechanism 312 positioned between a plate 316 fixed to the hitch member 304 and a second plate 320 mounted to the second frame 32. The swivel assembly 308 also includes a rod and handle assembly 324 and spring pin 328. The spring pin 328 contacts the swiveling mechanism 312 and is moved in and out of contact with the swiveling mechanism 312 by pulling and releasing, respectively, the rod and handle assembly 324. The rod and handle assembly 324 and spring pin 328 are operable in conjunction with the swiveling mechanism 312 to selectively lock the swivel assembly 308 in one of a plurality of swiveled positions.

In use, the device 288 is first mounted to the trailer hitch of the vehicle 24. The latch mechanism 228 holds the dump bed 40. If it is desirable to locate the dump bed 40 off to one of the sides of the vehicle 24, the handle of the rod and handle assembly 324 is pulled outward thereby releasing the spring pin 328 from the swiveling mechanism 312 to allow the second frame 32, and therefore the dump bed 40, to be swiveled or turned to a desired position, preferably 90 degrees from its original position. The rod and handle assembly 324 is released and the spring pin 328 mates with the swiveling mechanism 312 to secure the dump bed 40 in the desired position. The spring rod 232 is moved to release the lock latch mechanism 228. When the spring rod 232 is so positioned, the dump bed 40 may be moved outward with respect to the second frame 32. Once the dump bed 40 is properly extended outward, one of the levers 292 (depending on which side of the dump bed 40 the operator is standing) is activated to release the actuating mechanism 180 to allow the dump bed 40 to dump. Once the dumping action is complete, the dump bed 40 is put back into its non-dumping position in much the same fashion as the embodiments discussed above.

Alternate embodiments of the transporting devices can be derived from the embodiments described above and still be covered under the present invention. Other alternative embodiments will be apparent to those skilled in the art and are within the intended scope of the present invention. Thus, the present invention is to be limited only by the following claims.

1. A transporting accessory for a vehicle, the transporting accessory comprising:
a base frame mountable to the vehicle, the base frame having two support members;
a second frame having two extension members, each extension member slidably borne by a respective one of the support members, each extension member having at least one guide device and being movable along a path of travel between a first, retracted position and a second, extended position;
a carriage pivotally mounted to the second frame, the carriage having at least one arm, the at least one arm having at least one guide device, the carriage movable between a first, substantially parallel position and a second, inclined position; and
a transport support at least one track, the at least one track slidably borne by the at least one guide device of the carriage, the transport support being movable along a path of travel between a first, retracted position and a second, extended position and positioned such that the transport support contacts at least one guide device of each extention member when the transport device is in the retracted position.

2. The transporting accessory as claimed in claim 1, further comprising a drive assembly operable to move the extension members between the first, retracted position and the second, extended position.

3. The transporting accessory as claimed in claim 2, further comprising an actuating mechanism coupled to the second frame and the carriage, the actuating mechanism operable to pivot the carriage.

4. The transporting accessory as claimed in claim 3, wherein the actuating mechanism is a electric actuator.

5. The transporting accessory as claimed in claim 1, further comprising a drive assembly operable to move the extension members between the first, retracted position and the second, extended position.

6. A transporting accessory for a vehicle, the transporting accessory comprising:
a base frame mountable to the vehicle, the base frame having two support members;
a second frame having two extension members, each extension member including at least one roller slidably borne by a respective one of the support members, each extension member movable along a path of travel between a first, retracted position and a second, extended position;
a carriage pivotally mounted to the second frame, the carriage having two parallel side arms, each side arm having at least one roller;
a transport support having two tracks, each track slidably borne by the at least one roller of one of the two parallel side arms, the transport support being movable along a path of travel between a first, retracted position and a second, extended position;
a drive assembly operable to move the extension members between the first, retracted position and the second, extended position; and
an actuating mechanism coupled to the second frame and the carriage, the actuating mechanism operable to move the transport support between the first, retracted position and the second, extended position.

7. The transporting accessory as claimed in claim 6, wherein the actuating mechanism is a electric actuator.

8. A transporting accessory for a vehicle, the transporting accessory comprising:
a base frame mountable to the vehicle, the base frame having two support members;
a second frame having two extension members, each extension member including at least one roller slidably borne by a respective one of the support members, each extension member movable along a path of travel between a first, retracted position and a second, extended position;
a carriage pivotally mounted to the second frame, the carriage having two parallel side arms, each side arm having at least one roller;
a transport support having two tracks, each track slidably borne by the at least one roller of one of the two parallel side arms, the transport support being movable along a path of travel between a first, retracted position and a second, extended position; and
a drive assembly operable to move the extension members between the first, retracted position and the second, extended position and move the transport support between the first, retracted position and the second, extended position.

9. A method of loading and unloading cargo into and from a transporting accessory for a vehicle, the method comprising:
mounting a base frame of the transporting accessory to the vehicle, the base frame having two support members;
positioning the cargo into a transport support of the transporting accessory,
activating a drive assembly a first time to move two extension members of a second frame of the transporting accessory along a telescoping path of travel with respect to the base frame between a first, retracted position and a second, extended position;
activating an actuating mechanism a first time to pivot a carriage and to move a transport support along a transport support path of travel between a first, retracted position and a second, extended position, the actuating mechanism being coupled to the second frame and a carriage, the carriage being pivotally mounted to the second frame;
activating the actuating mechanism a second time to pivot the carriage to cause the transport support to move along the transport support path of travel between the second, extended position and the first, retracted position; and
activating the drive assembly a second time to move the two extension members along the telescoping path of travel between the second, extended position and the first, retracted position.
